(19) United States
(12) Patent Application Publication
(10) Pub. No.: US 2012/0195445 A1
(43) Pub. Date: Aug. 2, 2012

(54) SYSTEM FOR REMOTELY CONTROLLING AN AUDIO MIXER

(76) Inventor: Mark Inlow, Lisle, IL (US)

(21) Appl. No.: 13/015,291

(22) Filed: Jan. 27, 2011

(51) Int. Cl. H04B 1/00

(52) U.S. Cl. 381/119

(57) ABSTRACT

A system for wirelessly controlling an audio mixer is disclosed. The system includes a controller disposed between audio input lines and a conventional audio mixer. The controller is wirelessly controlled via a remote computing device. The computing device may be a tablet, smartphone, laptop, personal computing device, or other computing device. Ideally, the computing device includes a graphic user interface and transmits signals to the controller via a wireless protocol such as the IEEE 802.15.1 standard protocol currently known as BLUETOOTH. Thus, a user may operate the wireless computing device while in an audience area or off stage area during a performance. The mixer may remain on stage with the performers, thus avoiding the need for wired connections leading from a stage area to an off stage area.

### BACKGROUND OF THE INVENTION

1. Field of the Invention

The present invention relates to a system for remotely controlling an audio mixer, and more particularly, to a system for wirelessly controlling a conventional audio mixer.

2. Background

Musical performers who perform in various venues use a variety of audio equipment to enhance and control sound output. In certain situations, audio lines from various components of the performance are fed via wired connection to an offstage area where an operator will control an audio mixer to control the various audio components of the performance.

Some disadvantages of this arrangement are that multiple lines must be wired from the stage to the area, which can take up space, add expenses, create tripping hazards, etc. Furthermore, having an offstage area for audio controlling equipment can take up a great deal of space, which can be particularly problematic in smaller venues.

In certain situations, performers may keep an audio mixer on stage. However, another individual typically would need to stand in the audience area, either before or during the performance, to evaluate the sound levels and quality and provide verbal feedback to a performer so that the performer can adjust the audio mixer accordingly. This can be inefficient, and may detract from the performance.

Various systems have been developed to address the above problems. For example, Published Patent Application No. 2008/0091286 discloses a stage box which receives input lines from musical equipment, and provides controlled output to speakers. The stage box is remotely controlled. However, in such a system, a specialized stage box is required. Thus, performers already having conventional equipment would need to make a substantial investment in new equipment rather than using existing equipment.

While this, and various other processes may be known, currently, there is no sufficient or efficient method known heretofore for making use of existing audio equipment such as audio mixers. Thus, there continues to be a need for a system which does not require replacement of expensive audio mixing equipment, yet allows for wireless remote controlling of an audio mixer.

### SUMMARY

The present invention is a system for remotely controlling an audio mixer. The system enables a conventional mixer to be used, for example, in an onstage location. A controller is placed in line between standard audio input lines and an audio mixer having a plurality of audio channels.

The controller is linked to a wireless computing device via a wireless protocol, such as the IEEE 802.15.1 standard protocol currently known as BLUETOOTH. However, any suitable wireless protocol may be used. The wireless computing device may be any suitable device. For example, a personal computing device, a laptop computer, a tablet, or a smartphone device may be used.

The wireless computing device ideally includes a graphic user interface in order to allow the user to control various audio variables associated with individual audio input lines. For example, audio gain, equalizing, or muting/unmuting functions can be controlled from the wireless device. An overall master gain variable may also be controlled.

In various embodiments, a wireless signal from the wireless device is transmitted via a Universal Serial Bus (USB) attached signal transmitting device.

The system allows a user to control various audio variables from a location in an offstage or audience area either before or during a performance without having to communicate with someone onstage. Furthermore, a conventional audio mixer can be used within the system.

Still other objects and advantages of the present invention will become readily apparent to those skilled in the art from the following detailed description, wherein it is shown and described only the preferred embodiments of the invention, simply by way of illustration of the best mode contemplated of carrying out the invention. As will be realized, the invention is capable of other and different embodiments and its several details are capable of modifications in various obvious respects, without departing from the invention. Accordingly, the drawings, wherein like reference numerals represent like features, and description are to be regarded as illustrative in nature and not as restrictive.

### BRIEF DESCRIPTION OF THE DRAWINGS

FIG. 1 shows a front panel view of one embodiment of the controller of the present invention.

FIG. 2 shows the components of one embodiment of the system of the present invention.

FIG. 3 shows a block diagram of one embodiment of the controller of the present invention.

FIG. 4 shows a block diagram of a typical commercial audio mixer channel input as per one embodiment of the present invention.

FIG. 5 shows a tip ring sleeve audio patch cable as used between the controller and the audio mixer according to one embodiment of the present invention.

FIG. 6 shows a master/slave controller component setup according to one embodiment of the present invention.

FIG. 7 shows a flow chart illustrating one embodiment of a process for running the controller of the present invention.

### DETAILED DESCRIPTION OF THE INVENTION

While this invention is susceptible of embodiments in many different forms, there are shown in the drawings and will herein be described in detail, preferred embodiments of the invention with the understanding that the present disclosure is to be considered as an exemplification of the principles of the invention and is not intended to limit the broad aspect of the invention to the embodiments illustrated.

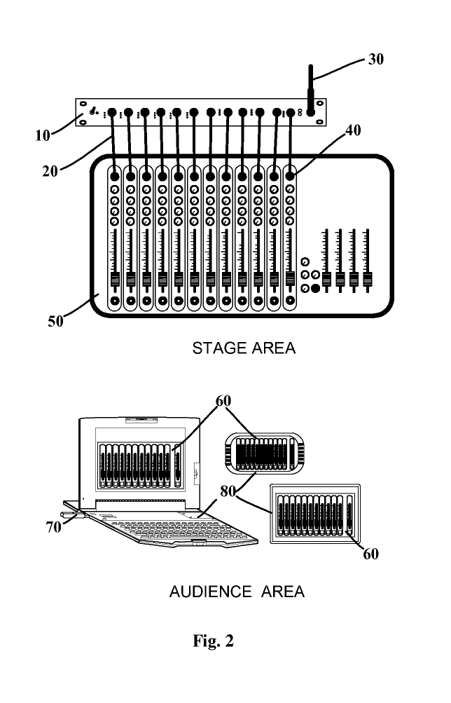

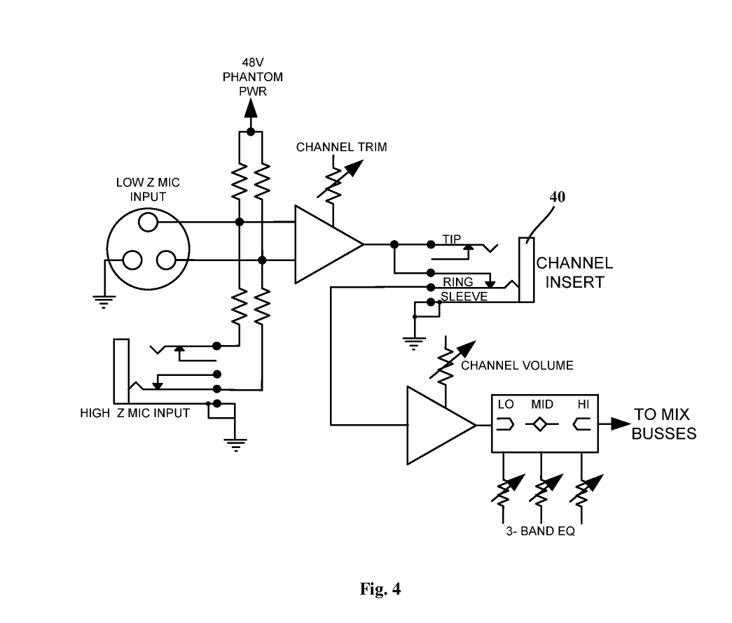

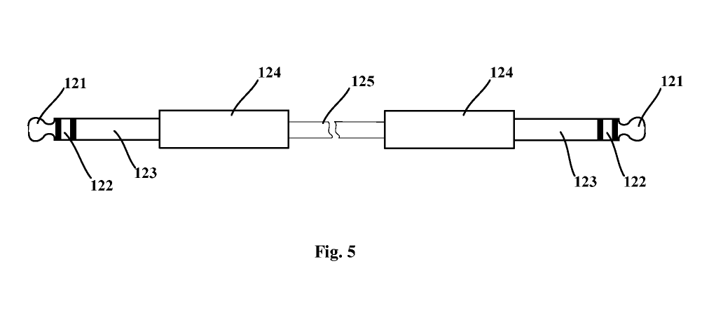

The present invention is a system for remotely controlling an audio mixer 50. FIG. 2 shows one embodiment of the system of the present invention. The controller 10 receives a plurality of audio channel lines as input lines. Any number of audio lines may be fed into controller 10. Such lines typically would include at least four audio lines, and stem from live performance audio equipment components such as a microphone and musical instruments played by an individual. Patch cords 20 connect the respective channels between the controller 10 and the mixer 50. FIG. 4 shows a typical audio mixer channel input block diagram with a channel insert 40. Patch cords may be any desired configuration, however, a standard tip-ring-sleeve patch cord such as that shown in FIG. 5 is preferred. Such a cord may include a jack tip connection 121, a jack ring connection 122, a jack sleeve connection 123, a jack body 124, and audio twisted-shielded pair cable 125. The controller 10 may have an antenna 30 for receiving a wireless signal.

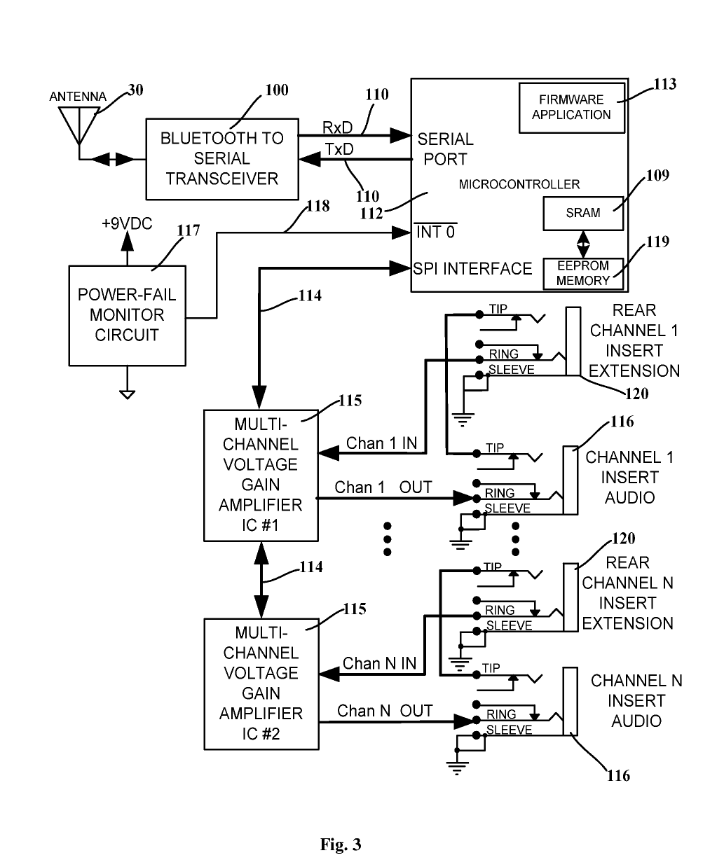

FIG. 3 shows one possible configuration of a controller 10 according to the present invention. In one preferred embodiment, the controller 10 includes an antenna 30, such as a BLUETOOTH antenna, an Original Equipment Manufacturer (OEM) BLUETOOTH-to-serial transceiver 100, a serial data port 110, a microcontroller 112, a firmware application program 113, a Serial Peripheral Interface (SPI) data bus 114, a multi-channel voltage gain amplifier 115 such as a Cirrus Logic CS3318, an audio channel insert jack 116, a power fail monitor circuit 117, an interrupt control line 118, an Electrically Erasable Programmable Read-Only Memory (EEPROM) memory area 119 of the microcontroller 112, and a rear channel insert extension 120. The rear channel insert extension 120 would allow a user to have additional insert capability, such as to obtain other audio effects.

As illustrated in FIG. 2, the system further includes a wireless computing device 80. The device 80 may be any suitable computing device. For example, it may be a tablet, a smartphone, a laptop or notebook computer, a personal computing device, a special purpose device, or any other suitable device. By personal computing device, any computing device suitable for this purpose, meaning a personal computer (PC), or computer of any type is contemplated. The computing device 80 ideally includes a Graphic User Interface (GUI) 60 which allows the user to control at least one audio variable associated with each of the plurality of audio input lines. The wireless device 80 then transmits a wireless signal to the controller 10.

The wireless signal may be transmitted via any suitable wireless technology. For example, the IEEE 802.15.1 standard protocol currently known as BLUETOOTH may be used, infrared, radio frequencies, or any other suitable wireless technology may be used. In certain embodiments, the transmission of the wireless signal may be enabled by a peripheral device such as a USB transmitting device.

The user can control at least one audio signal associated with each input line. For example, the user may be allowed to control a gain variable, an equalizing variable, a mute/unmute condition, or a master gain function. Any combination, or all of the above variables may be controllable via the wireless device 80.

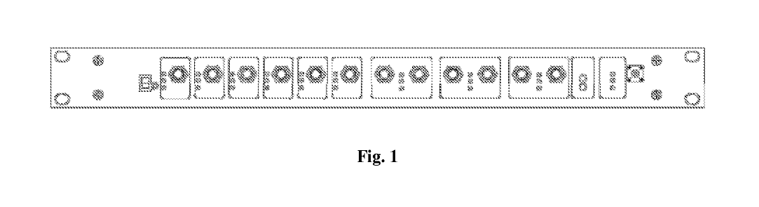

In various embodiments, the system of the present invention includes two parts, a controller box 10 (See FIGS. 1, 2) that receives wireless, for example, the IEEE 802.15.1 standard protocol currently known as BLUETOOTH, audio variables such as gain control commands, and a laptop, personal computing device, smart phone, tablet, or other computing device 80, preferably loaded with mixer control software 60. In this way, a user can send wireless signals to the controller 10 to control any of various audio variables, including but not limited to audio gain, equalizer variables such as bass and treble gains, mute or unmute conditions, or overall gain of the entire system.

In certain embodiments, an OEM USB Class 1 IEEE 802.15.1 standard protocol, commonly known as BLUETOOTH, device 70 is installed in one of the USB ports. This laptop or personal computing device/BLUETOOTH combination, smart phone or tablet transmits audio variables such as gain control commands to the controller box 10 on stage.

The method of transmitting and receiving signals wirelessly via BLUETOOTH Technology can be easily understood by those skilled in the art so that a detailed explanation thereof is omitted.

In various embodiments, the controller box 10 is located in close proximity to the mixing board 50 on stage. Tip-ring-sleeve audio patch cords 20 connect each channel of the mixer's audio inserts 40 to each corresponding channel of the controller box 10. A person in the audience with the laptop, personal computing device, smart phone, or tablet moves graphical representations of channel gain slide controls up and down to change the audio gain of each channel adjusting the sound mix of the performance as required. The controlling program in the laptop, personal computing device, smart phone, or tablet 80 transmits changes in audio variables such as audio gain change, and channel muting commands serially via either a built-in BLUETOOTH interface, or an external USB-to-BLUETOOTH device to the controller box 10.

In certain embodiments, the commands are received at the antenna 30 (See FIG. 3) connected to an OEM BLUETOOTH-to-serial interface 100 in the controller box 10. Serial data 110 is then routed to a microcontroller 112 in the controller box 10 for interpretation.

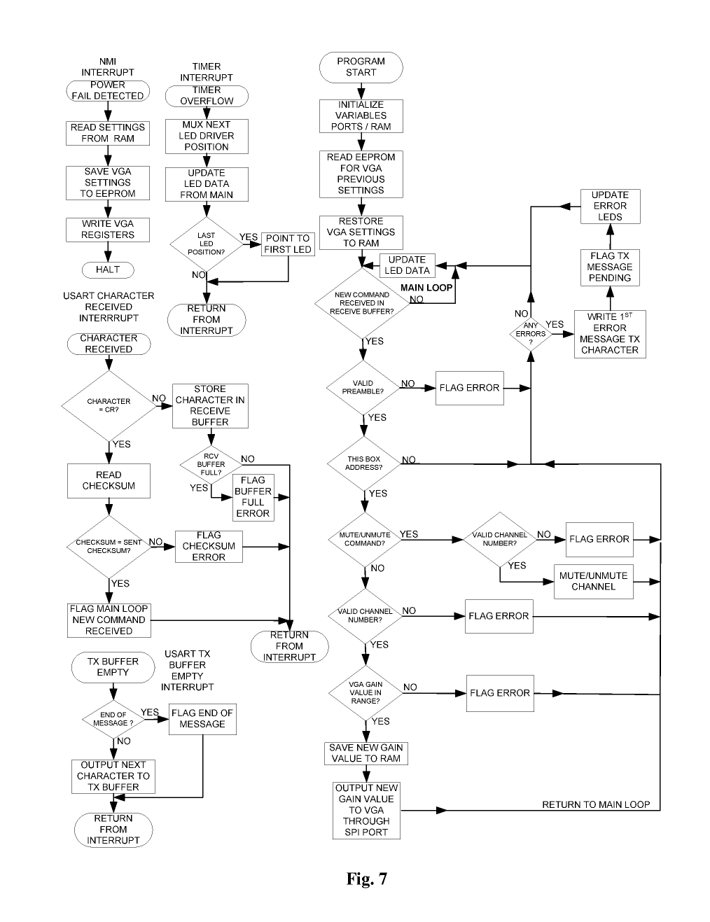

FIG. 7 shows a flowchart illustrating certain embodiments of the process required to run the controller. In various embodiments, based on the interpreted commands, the microcontroller's application firmware sends a data stream via its SPI bus to two multi-channel Voltage Gain Amplifier (VGA) Integrated Circuits (ICs), thereby changing an individual channel's gain, a channel's mute/un-mute condition, or the overall master gain of the control box. Gain control changes for each channel of the mixer are made by the insertion of the controller's internal gain control device ICs into the audio path of each of the mixer channel inputs at channel insert jacks 40.

In certain preferred embodiments, a power-fail monitor circuit 117 detects when the controller box +9 Volts Direct Current (VDC) input power falls below a certain level, indicating a power off or power fail condition. The monitor circuits' output goes to a logic low level and generates an interrupt 118 to the microcontroller 112. The interrupt handler first puts the VGA's 115 into a power-down state, thereby muting all channels to minimize any audible artifacts. The interrupt handler then saves a copy of all VGA gain, sub bus assignments, and mute register Static Random Access Memory (SRAM) 109 data values to the CPU's EEPROM non-volatile data area of memory 119. This EEPROM data is always read back to the volatile SRAM copy 109, and also the data is re-written via the SPI port 114 to the VGA data registers after a power-on reset is issued. This insures that all previous gain, sub bus assignments, and channel mute status are restored to the way they were at the power-fail.

In various alternate embodiments, in addition to controlling the gain of each individual channel, channel equalization, parametric audio filters and effect levels would be added in the audio insert path, controllable by commands received from the laptop or personal computing device GUI.

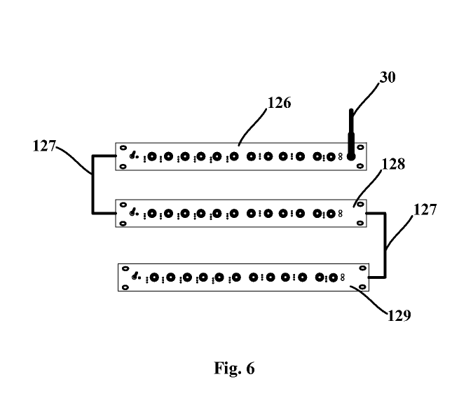

In still other embodiments, the number of channels could be expanded by adding an additional slave control box's link input to the master controller box's link output with, for example, short RJ-45 patch cords. This expands the buffered BLUETOOTH serial control and address lines to the next box. The first controller box is called the master and is hard wired to have an Idendification (ID) address of 1. The next slave controller box becomes ID address 2. If an additional slave is added to the previous slaves link output, the ID address becomes 3, and so on. For example, FIG. 6 shows a master controller 126 and two slave components 128 and 129 are added. Master controller 126 and slave components 128, 129 may be interfaced via patch cords 127. Multiple GUI programs may be opened on the controlling laptop, each having a matching control box ID address set, or a single GUI, having multiple panels each with its own ID address set.

While specific embodiments have been illustrated and described, numerous modifications come to mind without significantly departing from the spirit of the invention and the scope of protection is limited by the scope of the accompanying claims.

What is claimed is:

1. A system for remotely controlling an audio mixer comprising:
a controller having a plurality of audio channel input receiving elements adapted to receive audio input from a respective plurality of audio lines leading from live performance equipment components, and having a respective plurality of audio output elements adapted to output respective audio signals to a respective plurality of audio lines for providing input to an audio mixer, wherein said controller further comprises a wireless signal receiving device, and
a wireless computing device having a user interface adapted to allow a user to control at least one audio variable associated with each of said plurality of audio lines, wherein said wireless computing device has a wireless signal transmitter adapted to transmit a signal to said controller.

2. The system for remotely controlling an audio mixer according to claim 1, wherein said plurality of audio channel input receiving elements comprises at least four audio channel input receiving elements, and wherein said respective plurality of audio output elements comprises at least four audio output elements.

3. The system for remotely controlling an audio mixer according to claim 2, wherein said plurality of audio lines comprises at least one audio line leading from a microphone or musical instrument playable by a human.

4. The system for remotely controlling an audio mixer according to claim 3, wherein said plurality of audio channel input receiving elements and said plurality of audio output elements are adapted to receive tip-ring-sleeve inserts.

5. The system for remotely controlling an audio mixer according to claim 4, wherein said at least one audio variable is an audio gain variable.

6. The system for remotely controlling an audio mixer according to claim 4, wherein said at least one audio variable is an audio equalizer variable.

7. The system for remotely controlling an audio mixer according to claim 4, wherein said at least one audio variable is an audio mute variable.

8. The system for remotely controlling an audio mixer according to claim 4, wherein said wireless computing device is a tablet device.

9. The system for remotely controlling an audio mixer according to claim 4, wherein said wireless computing device is a smartphone device.

10. The system for remotely controlling an audio mixer according to claim 4, wherein said wireless computing device is a laptop or notebook computer.

11. The system for remotely controlling an audio mixer according to claim 4, wherein said wireless computing device is a personal computing device.

12. The system for remotely controlling an audio mixer according to claim 4, wherein said wireless computing device includes a graphic user interface adapted to allow a user to control said at least one audio variable via said graphic user interface.

13. The system for remotely controlling an audio mixer according to claim 4, wherein said wireless transmitter signal follows the IEEE 802.15.1 standard protocol.

14. The system for remotely controlling an audio mixer according to claim 4, wherein said wireless transmitter signal is a radio frequency transmitter device.

15. The system for remotely controlling an audio mixer according to claim 4, wherein said wireless computing device is further adapted to allow a user to control an overall master gain associated with said controller.

16. The system for remotely controlling an audio mixer according to claim 4, wherein said wireless signal transmitter is a USB peripheral device connected to said wireless computing device.

17. A system for remotely controlling an audio mixer comprising:
a controller having a plurality of audio channel input receiving elements adapted to receive audio input from a respective plurality of audio lines leading from live performance equipment components, and having a respective plurality of audio output elements adapted to output respective audio signals to a respective plurality of audio lines for providing input to an audio mixer, wherein said controller further comprises a wireless signal receiving device, wherein said controller is adapted to be wirelessly controlled by a wireless computing device having a user interface adapted to allow a user to control at least one audio variable associated with each of said plurality of audio lines, and wherein said wireless computing device has a wireless signal transmitter adapted to transmit a signal to said controller.
